(19) United States
(12) Patent Application Publication
(10) Pub. No.: US 2007/0090739 A1
(43) Pub. Date: Apr. 26, 2007

(54) Focusing assembly of xenon lamp with two light emitting cores

(76) Inventor: Jack Lin, Taipei Hsien (TW)

Correspondence Address: Jack Lin, 235 Chung - Ho, Box 8-24, Taipei, TW

(21) Appl. No.: 11/256,771

(22) Filed: Oct. 25, 2005

(51) Int. Cl. H01K 1/26; H01J 5/48; H01J 17/02

(52) U.S. Cl. 313/114; 313/113; 313/318.11; 313/626

(57) ABSTRACT

A focusing assembly of a xenon lamp with two light emitting cores comprises a xenon lamp having a light focusing plate; the light focusing plate being a cambered sheet; a rear end of the light focusing plate having at least one pin; the pin being slightly bent outwards; a lower end of the pin being formed with a bending sheet with a smaller size than that of the pin; a lamp seat having at least one embedding hole for embedding the light focusing plate by receiving the bending sheet of the light focusing plate and then bending the bending sheet so as to fix the light focusing plate; a quartz glass tube connected at an upper side of the lamp seat; and two light emitting cores being installed within the quartz glass tube; each of the light emitting core being connected to a respective ceramic tube.

### FIELD OF THE INVENTION

The present invention relates to xenon lamps, and in particular to a focusing assembly of a xenon lamp with two light emitting cores, wherein a light focusing plate is used to focus light so as to avoid flash in driving and to assure the safety in driving the car equipped with the lamp.

### BACKGROUND OF THE INVENTION

Referring to FIG. 1, a prior art focusing assembly of a xenon lamp with two light emitting cores is illustrated. In the prior art, the xenon lamp 100, see FIG. 1, has a quartz glass tube 200, two light emitting cores 300, a lamp seat 400, a ceramic tube 500, and far and near high voltage wires. A light-focusing coating area 600 is formed on the quartz glass tube 200 for focusing light and then emitting light from the lighting emitting cores 300 through a cover. However in the prior art, the coating area 600 is easy to be destroyed in transferring and installation, or the coating will fall down when it is used for a long time. Moreover the cost is high. Furthermore, the prior art will generate strong flash 700 (referring to FIG. 2) due to the light from the cars at the backside so as to affect the driver, see FIG. 700.

### SUMMARY OF THE INVENTION

Accordingly, the primary object of the present invention is to provide a focusing assembly of a xenon lamp with two light emitting cores, wherein a light focusing plate is used to focus light so as to avoid flash in driving and to assure the safety in driving.

To achieve above objects, the present invention provides a focusing assembly of a xenon lamp with two light emitting cores comprises a xenon lamp having a light focusing plate; the light focusing plate being a cambered sheet; a rear end of the light focusing plate having at least one pin; the pin being slightly bent outwards; a lower end of the pin being formed with a bending sheet with a smaller size than that of the pin for embedding the light focusing plate; a lamp seat having at least one embedding hole for embedding the light focusing plate by receiving the bending sheet of the light focusing plate and bending the bending sheet so as to fix the light focusing plate; a quartz glass tube connected at an upper side of the lamp seat; and two light emitting cores being installed within the quartz glass tube; each of the light emitting core being connected to a respective ceramic tube.

The various objects and advantages of the present invention will be more readily understood from the following detailed description when read in conjunction with the appended drawing.

### BRIEF DESCRIPTION OF THE DRAWINGS

FIG. 1 shows a prior art xenon lamp.

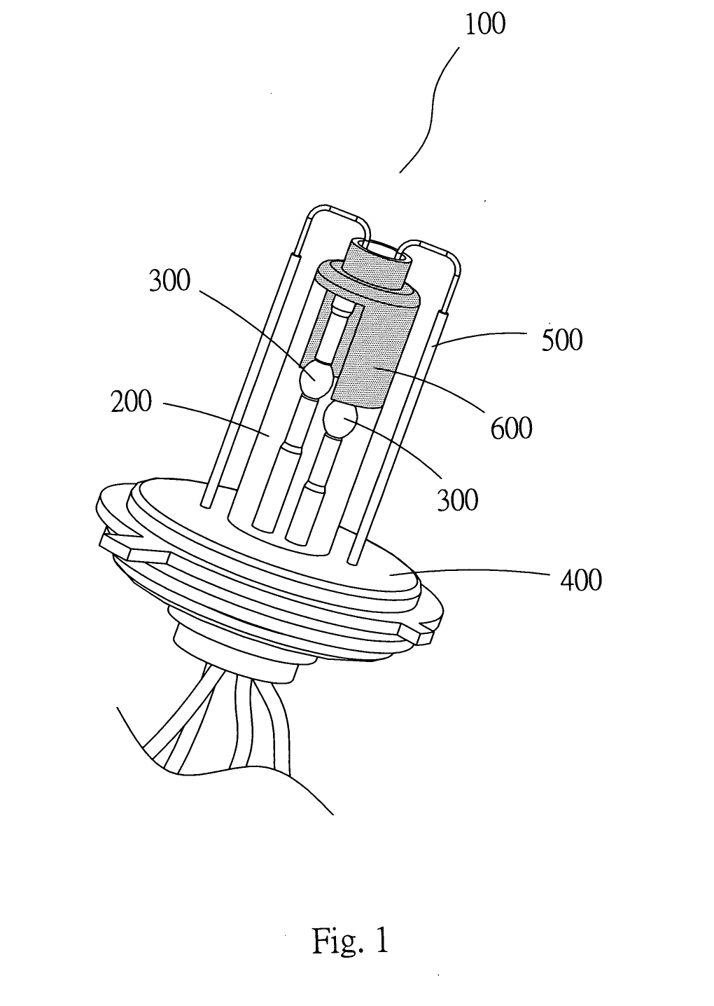

FIG. 2 shows the flash affect of the prior art car light.

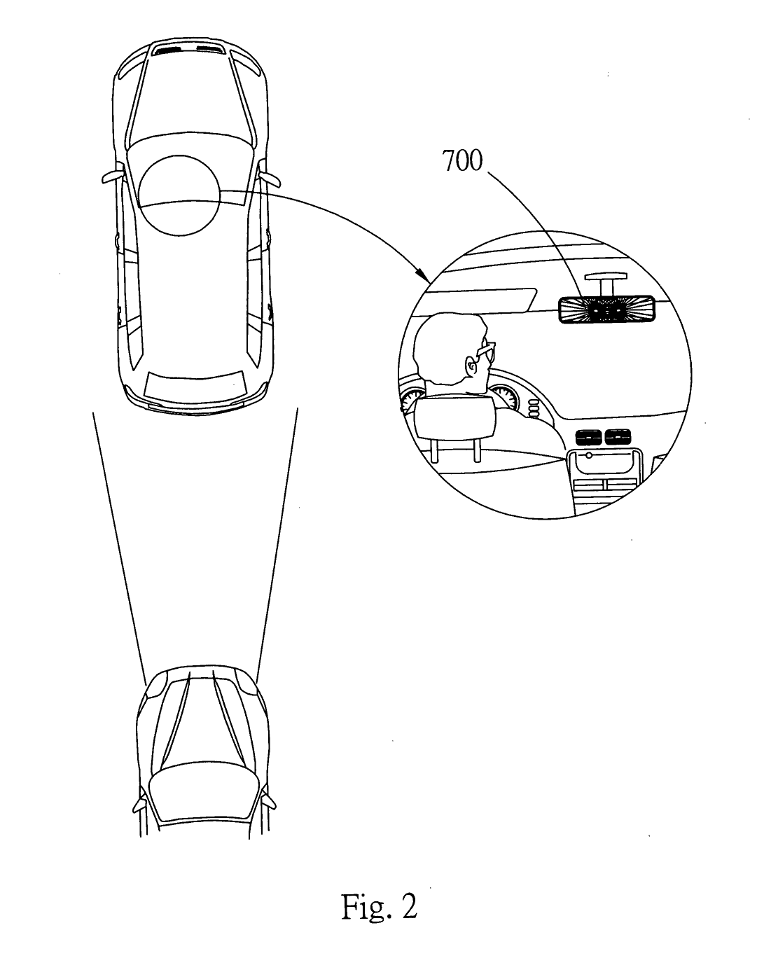

FIG. 3 is an assembled view of the present invention.

FIG. 4 shows the embodiment of the light focusing plate of the xenon lamp.

FIG. 5 is an exploded view of the present invention.

FIG. 6 shows the application of the present invention.

### DETAILED DESCRIPTION OF THE INVENTION

In order that those skilled in the art can further understand the present invention, a description will be described in the following in details.

However, these descriptions and the appended drawings are only used to cause those skilled in the art to understand the objects, features, and characteristics of the present invention, but not to be used to confine the scope and spirit of the present invention defined in the appended claims.

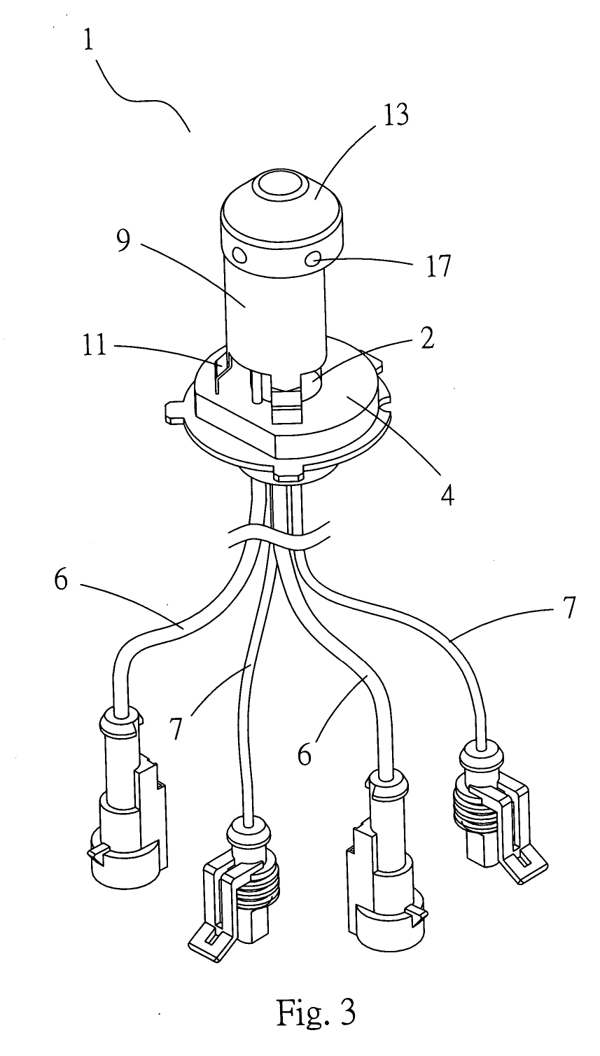

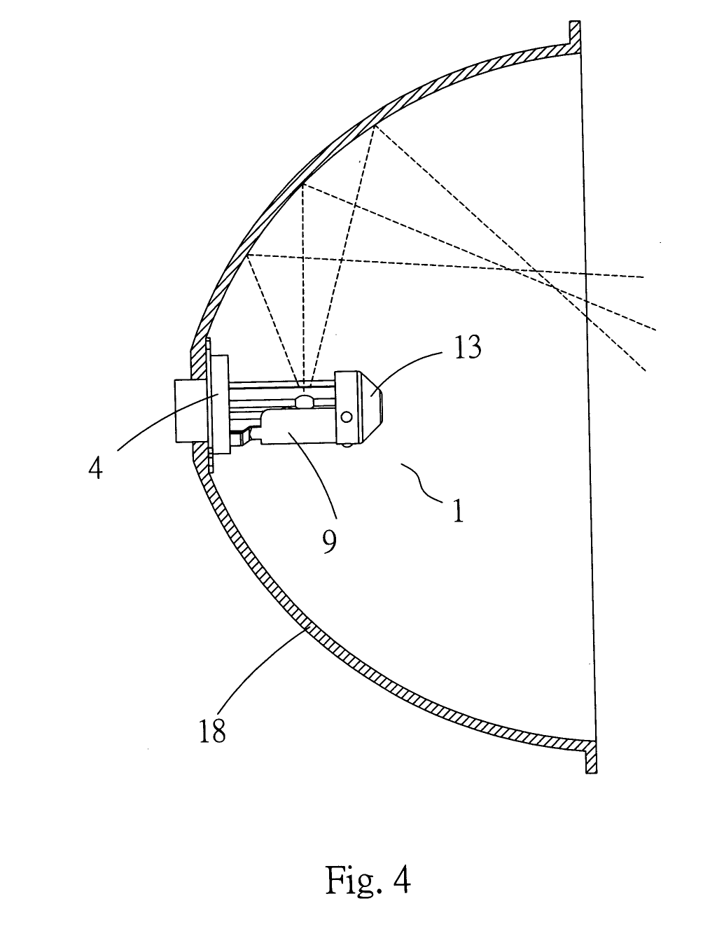

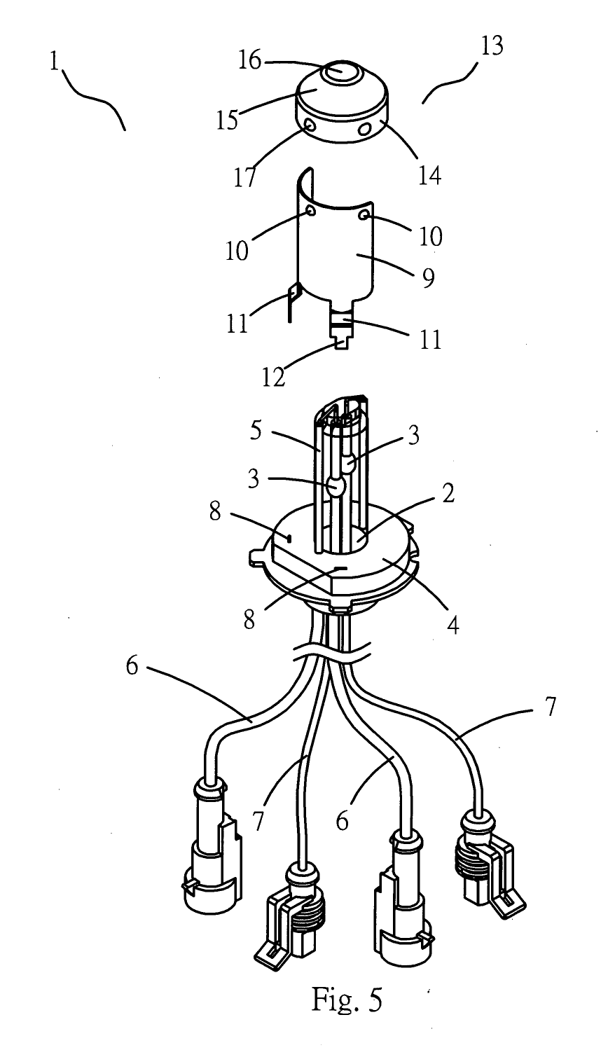

Referring to FIGS. 3, 4, 5 and 6, the present invention is illustrated. The present invention has the following elements.

A xenon lamp 1 has a light focusing plate 9 for focusing light and emitting light. The light focusing plate 9 is a cambered sheet. A front end thereof is punched with noses 10 at an outer side of the light focusing plate 9. A rear end of the light focusing plate 9 has at least one pin 11. The pin 11 is slightly bent outwards. A lower end of the pin 11 is formed with a bending sheet 12 with a smaller size than that of the pin 11.

A lamp seat 4 has at least one embedding hole 8 for embedding the light focusing plate 9 by receiving the bending sheet 12 of the light focusing plate 9 and then bending the bending sheet 12 so as to fix the light focusing plate 9. The shape of the embedding hole 8 is not confined, which may be selected from one of round shapes, rectangular shapes, star shapes, trapezoidal shapes, etc.

A cover 13 at a top of the light focusing plate 9 serves for hindering light incident thereon so that the light can be focused on the light focusing plate 9. The cover 13 has an annular wall 14 as a base. An upper side of the annular wall 14 is connected to a sealed tapered surface 15. A top of the tapered surface 15 is connected to a round surface 16 so as to completely seal the interior of the cover 13. The annular wall 14 is punched with at least one cambered nose 17 for receiving the nose 10 of the light focusing plate 9.

Two near high voltage wires 6 are connected to the lamp seat 4.

Two far high voltage wires 7 are connected to the lamp seat 4.

A quartz glass tube 2 is connected at an upper side of the lamp seat 4.

Two light emitting cores 3 are installed within the quartz glass tube 2.

Each of the light emitting core 3 is connected to a respective ceramic tube 5.

Thereby light emitted from the light emitting core 3 is focused upon the light focusing plate 9 and then is beamed to a front side of a car so that the driver can have a clear view. Besides, cover 13 has the effect of enhancing the focusing of the light so as to have avoid the effect of strong flash.

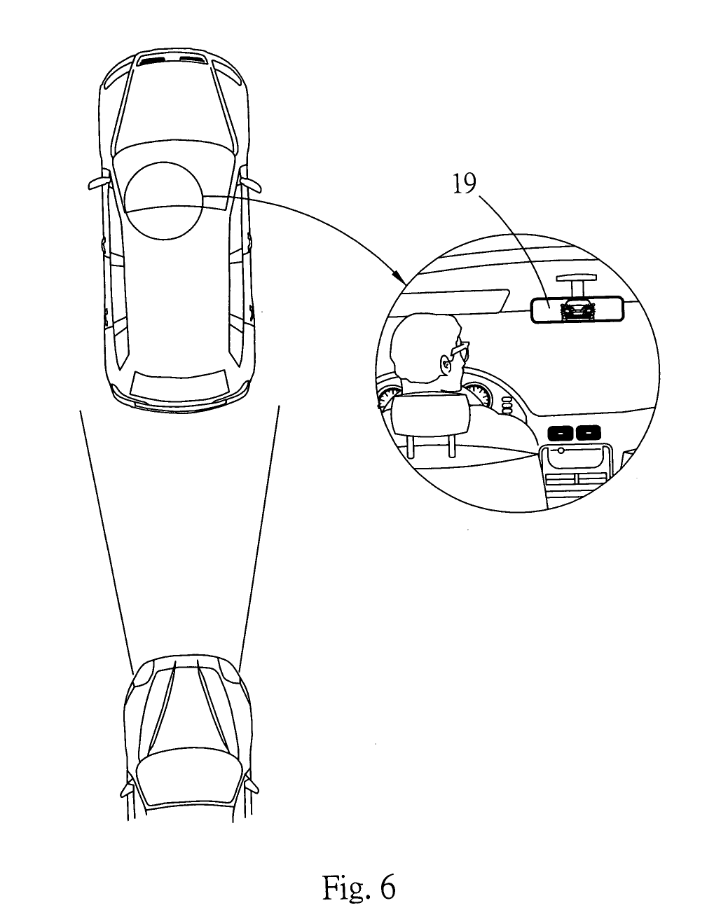

Referring to FIG. 6, when using the present invention, the user can view the rear mirror 19 without flash.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A focusing assembly of a xenon lamp with two light emitting cores comprising:
a xenon lamp having a light focusing plate for focusing light and emitting light; the light focusing plate being a cambered sheet; a rear end of the light focusing plate having at least one pin; the pin being slightly bent outwards; a lower end of the pin being formed with a bending sheet with a smaller size than that of the pin for retaining the light focusing plate;
a lamp seat having at least one embedding hole for embedding the light focusing plate by receiving the bending sheet of the light focusing plate and then bending the bending sheet so as to fix the light focusing plate;
two near high voltage wires being connected to the lamp seat;
two far high voltage wires being connected to the lamp seat;
a quartz glass tube connected at an upper side of the lamp seat; and
two light emitting cores installed within the quartz glass tube; each of the light emitting core being connected to a respective ceramic tube.

2. The focusing assembly of a xenon lamp with two light emitting cores as claimed in claim 1, wherein a shape of the embedding hole is selected from one of round shapes, rectangular shapes, star shapes, and trapezoidal shapes.

3. The focusing assembly of a xenon lamp with two light emitting cores as claimed in claim 1, wherein a front end thereof is punched with noses at an outer side of the light focusing plate.

4. The focusing assembly of a xenon lamp with two light emitting cores as claimed in claim 1, wherein a cover at a top of the light focusing plate serves for hindering light incident thereon so that the light can be focused on the light focusing plate; the cover has an annular wall as a base;
an upper side of the annular wall is connected to a sealed tapered surface;
and a top of the tapered surface is connected to a round surface so as to completely seal an interior of the cover.

5. The focusing assembly of a xenon lamp with two light emitting cores as claimed in claim 1, wherein the annular wall is punched with at least one cambered nose for receiving the nose of the light focusing plate.
